(19) United States
(12) Patent Application Publication
(10) Pub. No.: US 2017/0111091 A1
(43) Pub. Date: Apr. 20, 2017

(54) Method for Implementing an Uplink MU-MIMO Protocol for Data Transmission from Wireless User Stations to a Base Station

(71) Applicant: Kabushiki Kaisha Toshiba, Tokyo (JP)

(72) Inventors: Fengming CAO, Bristol (GB); Zhong FAN, Bristol (GB)

(73) Assignee: Kabushiki Kaisha Toshiba, Tokyo (JP)

(21) Appl. No.: 15/124,576

(22) PCT Filed: Jul. 11, 2014
(86) PCT No.: PCT/GB2014/052130

§ 371 Date: Sep. 8, 2016

(51) Int. Cl. H04B 7/04; H04W 74/08; H04W 56/00; H04L 5/00

(52) U.S. Cl. CPC H04B 7/0452; H04L 5/0048; H04L 5/0055; H04W 74/0816; H04W 56/0045

(57) ABSTRACT

A method for implementing an uplink MU-MIMO protocol comprising: transmitting a sounding announcement from a base station to a plurality of wireless user stations; receiving, at the base station, a respective sounding signal from two or more of the wireless user stations; determining the duration of a period by which each wireless user station from which a sounding signal has been received should offset its data transmission relative to the other wireless user stations from which a sounding signal has been received; sending control announcement information to each wireless user station from which a sounding signal has been received, the control announcement information including a spatial transmission scheme and timing correction information defining the period for which those user stations are to offset their data transmission from one another; receiving data from the wireless user stations; and processing the received data using the timing correction information and spatial transmission scheme.

### FIELD

Embodiments described herein relate to methods and systems for implementing an uplink MU-MIMO protocol for data transmission from wireless user stations to a base station.

### BACKGROUND

As the number of smart phones and other personal communication devices continues to grow, wireless local area networks (WLANs) are expected to see an ever-increasing load and density of users. The newly-formed IEEE802.11ax High Efficiency WLAN (HEW) group has considered a range of concepts for improving the performance of heavy-loaded and highly dense WLAN networks. Amongst the concepts considered are those involving MIMO (multiple input multiple output) techniques.

MIMO techniques are well known and have been adopted in various cellular communication systems. MIMO techniques can generally be divided into two categories: single user MIMO (SU-MIMO) and multiple-user MIMO (MU-MIMO). In SU-MIMO, data is sent from a single transmitter to a single receiver, whilst in MU-MIMO, data is either sent from a single transmitter to multiple receivers, or is sent from multiple transmitters to a single receiver. In the context of an infrastructure-mode WIFi network, the communication link from an access point or base station to a user station is referred to as a downlink (DL), whilst a link in the reverse direction (from the user station to the access point/base station) is referred to as the uplink (UL). To date, both SU-MIMO and Downlink Multiple User MIMO (DL-MU-MIMO) have been implemented in WiFi systems. Uplink Multiple User MIMO (UL-MU-MIMO) has also been put forward as an effective technique for improving average user throughput and the throughput of the system as a whole. However, precisely how to implement UL-MU-MIMO in WiFi systems remains an open issue.

### BRIEF DESCRIPTION OF FIGURES

Embodiments of the invention will now be described by way of example with reference to the accompanying drawings in which:

FIG. 1 shows a flow-chart of steps implemented at a base station according to an embodiment;

FIG. 2 shows a scheme for exchanging signals between a base station and a plurality of wireless user devices according to an embodiment;

FIG. 3 shows a scheme for exchanging signals between a base station and a plurality of wireless user devices according to an embodiment;

FIG. 4 shows an example of an embodiment in which scheduling-based sounding feedback is used for implementing a UL-MU-MIMO protocol;

FIG. 5 shows an example of how the delay between the expected arrival time of a sounding signal and the actual arrival time of the sounding signal may be determined in the scheduling-based method of FIG. 4;

FIG. 6 shows an example of an embodiment in which polling-based sounding feedback is used for implementing a UL-MU-MIMO protocol;

FIG. 7 shows an example of how the delay between the expected arrival time of a sounding signal and the actual arrival time of the sounding signal may be determined in the polling-based method of FIG. 6;

FIG. 8 shows an example of an embodiment in which wireless user stations compete to transmit sounding signals to a base station using a CSMA-CA protocol;

FIG. 9 shows an example of how the delay between the expected arrival time of a sounding signal and the actual arrival time of the sounding signal may be determined in the method of FIG. 8;

FIG. 10 shows an example format of a null data packet NDP for use as a sounding signal in embodiments described herein;

FIG. 11 shows an example format of a sounding announcement frame for use in embodiments described herein;

FIG. 12 shows an example format of a UL-MU-MIMO transmission announcement for use in embodiments described herein;

FIG. 13 shows an example format of an NDP report poll frame for use in embodiments described herein;

FIG. 14 shows an example format of an MU-RTS frame for use in embodiments described herein;

FIG. 15 shows an example format of an MU-CTS frame for use in embodiments described herein;

FIG. 16 shows an example format of an acknowledgement frame including a bitmap for communicating whether or not a base station has successfully received data sent from a wireless user station, in accordance with an embodiment; and

FIG. 17 shows a schematic of a base station according to an embodiment.

### DETAILED DESCRIPTION

According to a first embodiment, there is provided a method for implementing an uplink MU-MIMO protocol for data transmission from a plurality of wireless user stations to a base station, the method comprising:
transmitting a sounding announcement from the base station to the wireless user stations to solicit feedback of sounding signals from the wireless user stations;
receiving, at the base station, a respective sounding signal from two or more of the wireless user stations;
determining, based on the received sounding signals, the duration of a period by which each wireless user station from which a sounding signal has been received should offset its data transmission relative to the other wireless user stations from which a respective sounding signal has been received, so as to ensure synchronous arrival of data at the base station from those wireless user stations;
sending control announcement information to each wireless user station from which a sounding signal has been received, the control announcement information including a spatial transmission scheme and timing correction information defining the period for which those user stations are to offset their data transmission from one another;
receiving data sent from the respective wireless user stations to the base station; and
processing the received data based on the timing correction information and spatial transmission scheme.

In some embodiments, the control announcement information further comprises a respective frequency offset and/or transmission power to be implemented by each wireless user station.

In some embodiments, the sounding announcement is addressed to specific user stations to prompt those user stations to send their respective sounding signals to the base station.

In some embodiments, the sounding announcement defines an order in which the user stations are to send their respective sounding signals to the base station.

In some embodiments, the sounding announcement defines timings for when each user station is to transmit its respective sounding signal.

In some embodiments, on receipt of a respective sounding signal from a wireless user station, the base station transmits an acknowledgement to that user station.

In some embodiments, the transmission of the acknowledgement from the base station prompts the next user station to transmit its sounding signal.

In some embodiments, the sounding signals sent from the respective wireless user stations are sent from each station in turn based on a CSMA-CA protocol.

In some embodiments, the sounding signal received from a respective wireless user station includes the value of a back-off associated with that user station.

In some embodiments, the base station determines the duration of the period by which each respective wireless user station should offset its data transmission based on the delay between the expected arrival time of the respective sounding signal at the base station and the actual arrival time of the sounding signal at the base station.

In some embodiments, the base station determines the duration of the period by which each respective wireless user station should offset its data transmission by:
determining a first delay between the expected arrival time and actual arrival time of a sounding signal from a first one of the wireless user stations;
determining, for each one of the other user stations, the difference between the first delay and the delay between the expected arrival time and actual arrival time of the sounding signal from the respective wireless user station.

In some embodiments, the first one of the wireless user stations is the wireless user station for which the delay between the expected arrival time and actual arrival time is greatest.

In some embodiments, the first one of the wireless user stations is the wireless user station for which the delay between the expected arrival time and actual arrival time is smallest.

In some embodiments, before sending the sounding announcement, the base station determines whether a channel for sending the announcement is free based on a CSMA-CA protocol.

In some embodiments, the sounding signals take the form of null data packets.

In some embodiments, on receipt of data from a respective user station, the base station sends an acknowledgement to the user station.

In some embodiments, the acknowledgement sent on receipt of data includes a bitmap indicating whether the data has been successfully received.

According to a second embodiment, there is provided a non-transitory computer readable storage medium comprising computer executable instructions that when executed by a computer will cause the computer to carry out the method of the first embodiment.

According to a third embodiment, there is provided a base station for coordinating transmission of data from a plurality of wireless user stations using an uplink MU-MIMO protocol, the base station comprising:
a transmitter for transmitting a sounding announcement to the wireless user stations to solicit feedback of sounding signals from the wireless user stations;
a receiver for receiving a respective sounding signal from two or more of the wireless user stations;
a timing offset determination module for determining, based on the received sounding signals, the duration of a period by which each respective wireless user station from which a sounding signal has been received should offset its data transmission relative to the other wireless user stations from which a respective sounding signal has been received, so as to ensure synchronous arrival of data at the base station from those wireless user stations;
the transmitter being configured to send control announcement information to each wireless user station from which a sounding signal has been received, the control announcement information including a spatial transmission scheme and timing correction information defining the period by which those respective user stations are to offset their data transmissions relative to one another;
the receiver being configured to receive data sent from the respective wireless user stations to the base station using the spatial transmission scheme;
the base station including a processor for processing the received data based on the timing correction information and spatial transmission scheme.

According to a fourth embodiment, there is provided a wireless network comprising a base station according to the third embodiment and a plurality of wireless user stations, the wireless user stations being configured to transmit data to the base station via the uplink MU-MIMO protocol.

Embodiments described herein provide mechanisms for UL-MU-MIMO transmission that are backwards compatible with existing wireless networks and which will enable an access point or base station to obtain or estimate all the information that a feasible UL-MU-MIMO will require.

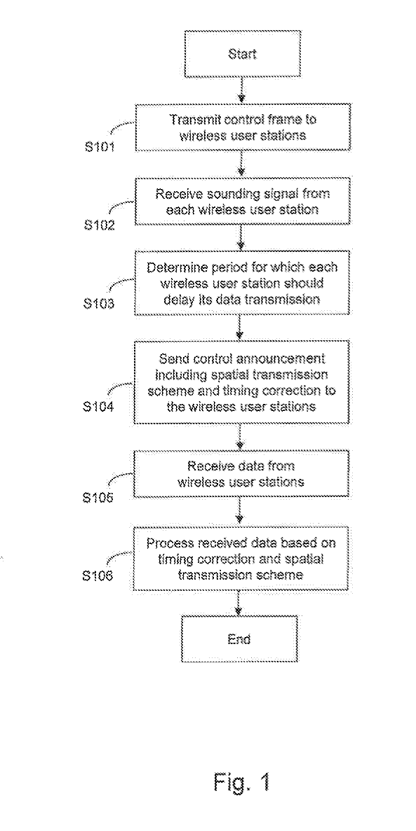

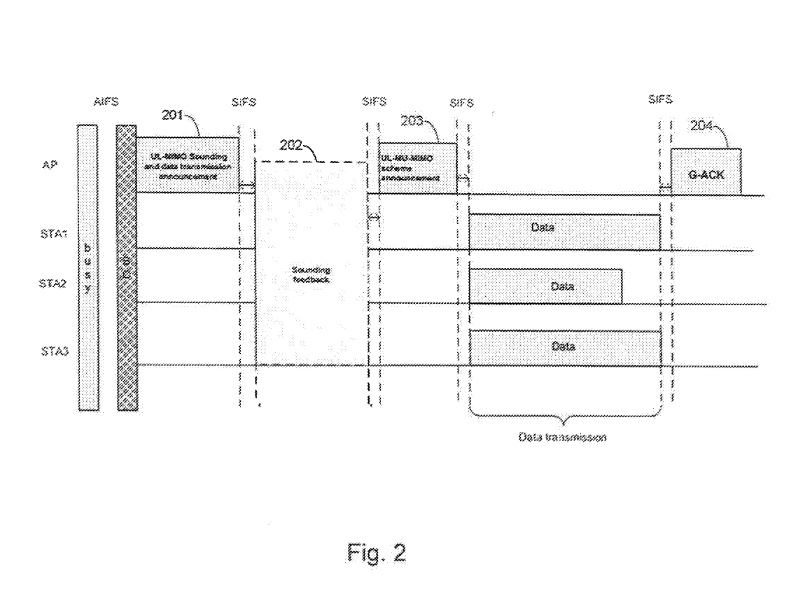

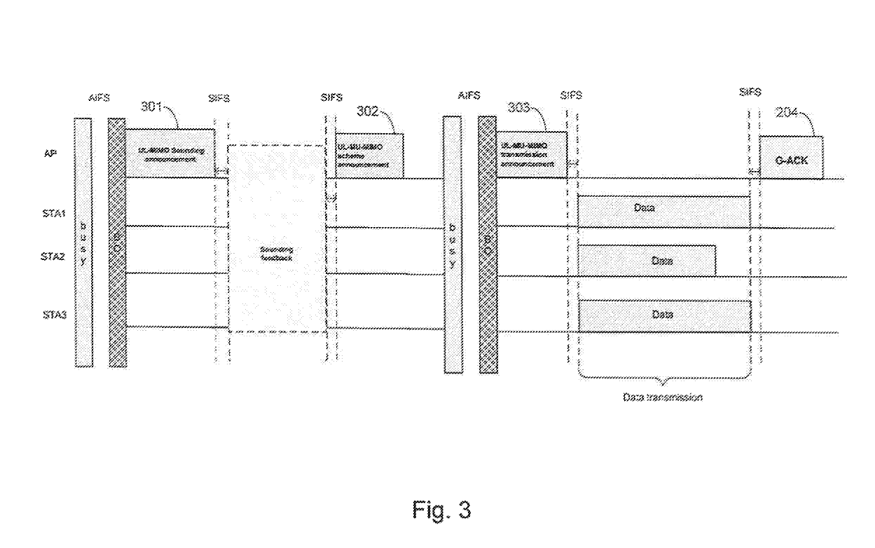

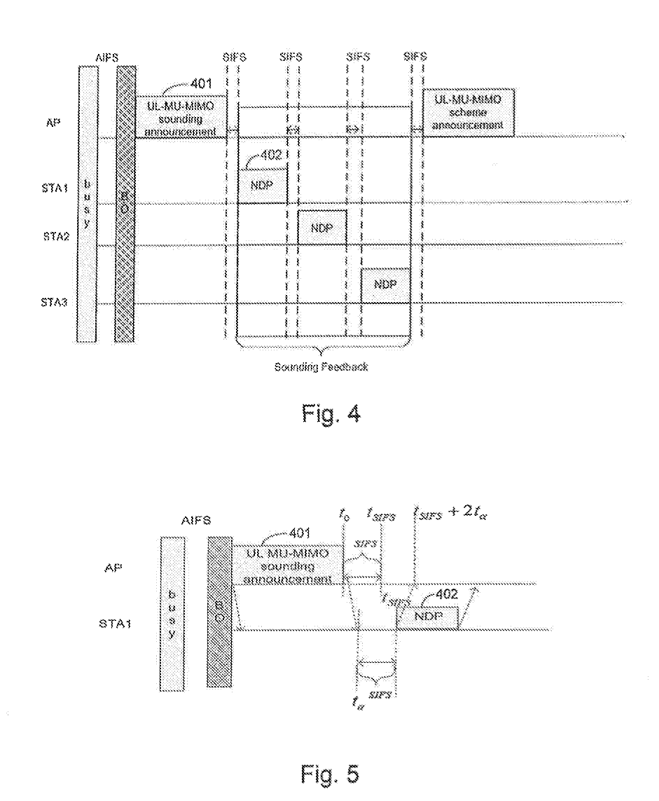

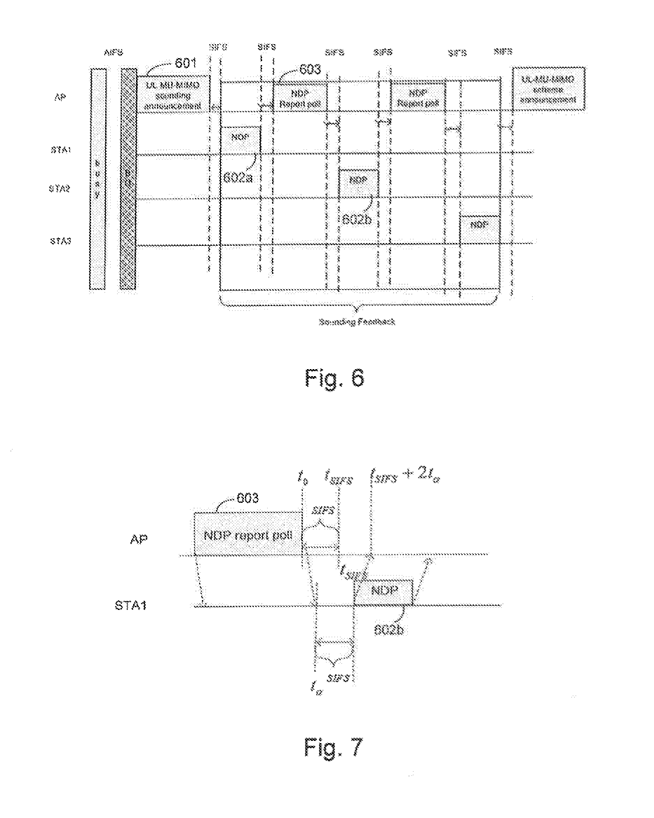

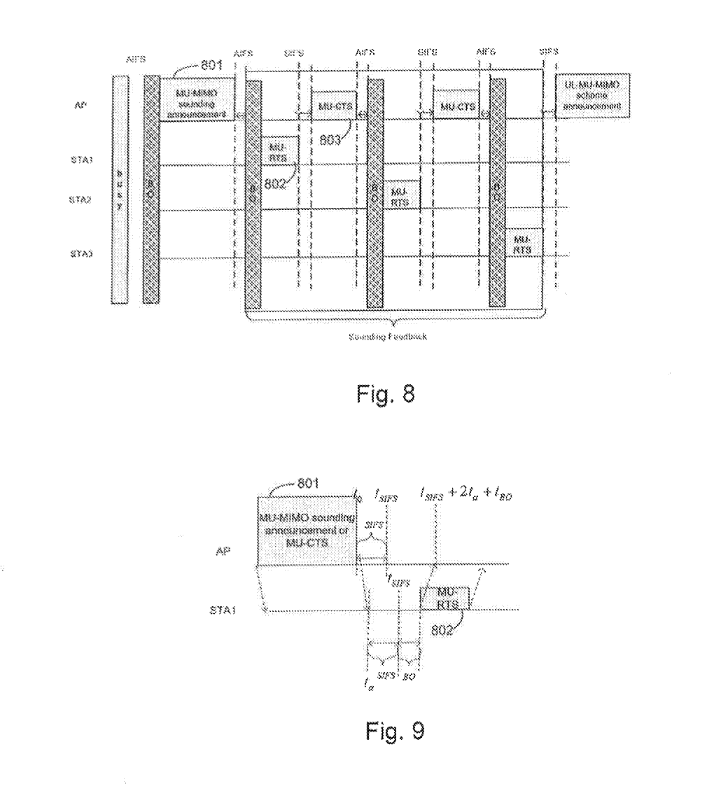

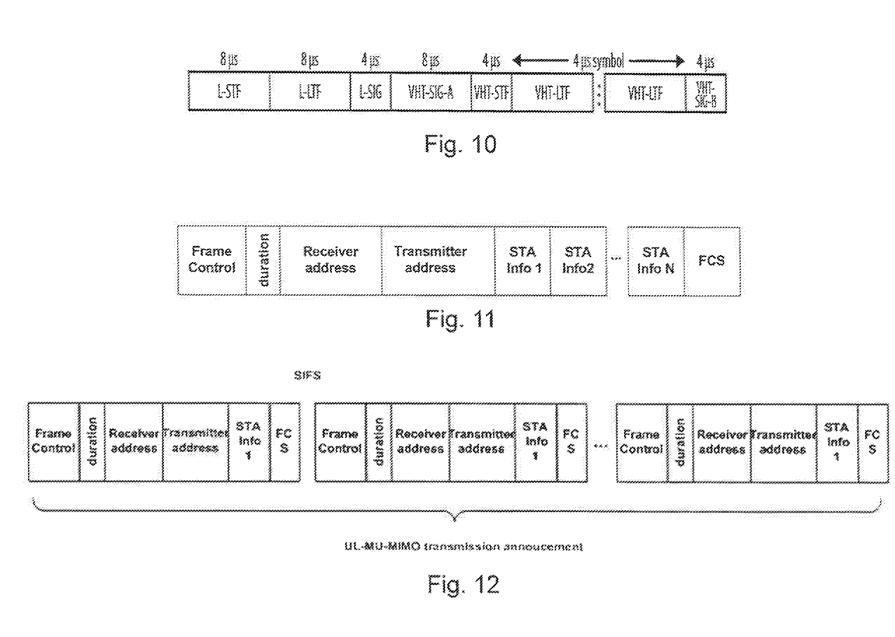

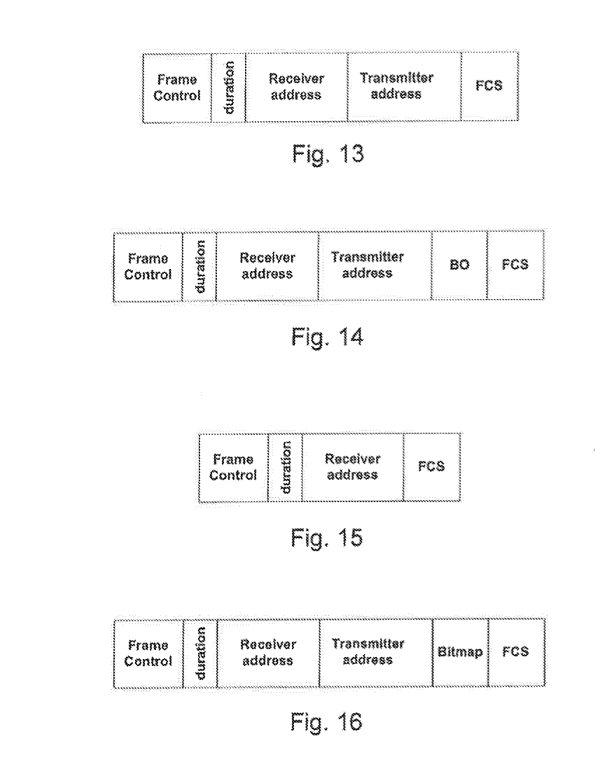

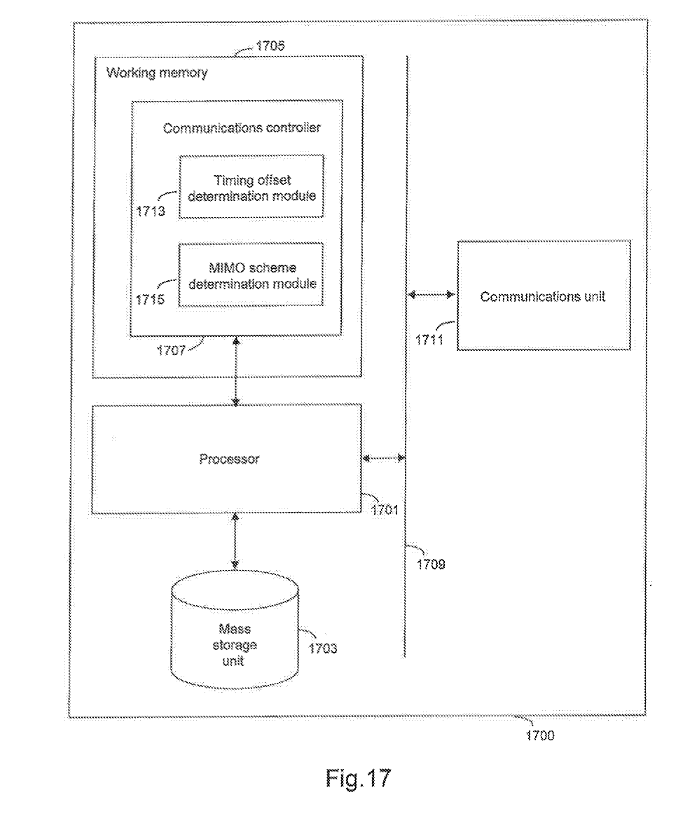

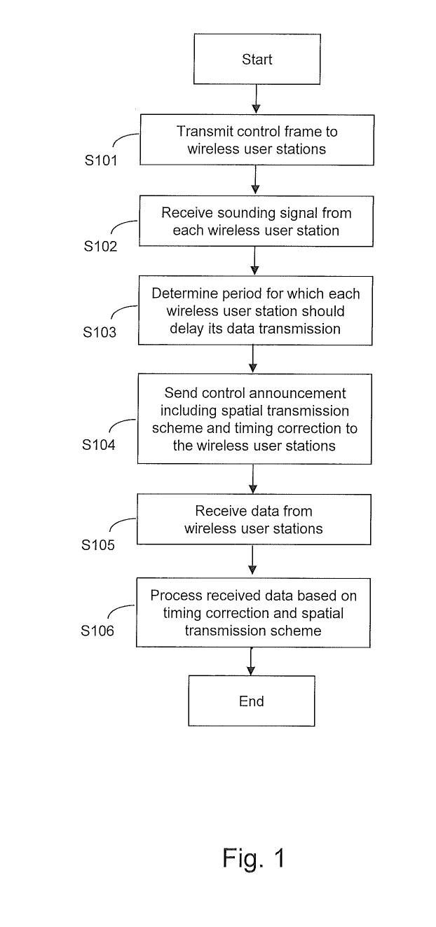

A first embodiment will now be described with reference to FIG. 1, which shows a flow-chart of steps implemented at a base station or access point that serves to provide one or more wireless user stations with access to a network, such as the internet, for example. Starting with step S101, the base station commences by transmitting a control frame including a sounding announcement to the wireless user stations. The purpose of the control frame is to solicit the different user stations to feed back sounding signals, which are then received by the base station (step S102). The base station uses the sounding signals that it receives back from the user stations for estimating communication parameters associated with each user station, including frequency offset, power control and radio channel quality. The base station uses the received sounding signals to determine the duration of a period by which the respective wireless user stations should offset their data transmissions, so as to ensure synchronous arrival of data at the base station from the wireless user stations (step S103). The base station further determines a spatial MIMO transmission scheme for uplink of data from the wireless user stations to the base station. The spatial MIMO transmission scheme may include, for example, the number of data streams, the type of modulation coding scheme, and precoding vector. In step S104, the base station sends a control announcement to the wireless user stations, where the control announcement includes details of the spatial transmission scheme and timing correction information defining the period by which the respective user stations are to delay their data transmissions. Following this, in step S105, the base station receives data transmitted from the different user stations and processes the received data based on knowledge of the transmission scheme and the timing corrections (step S106).

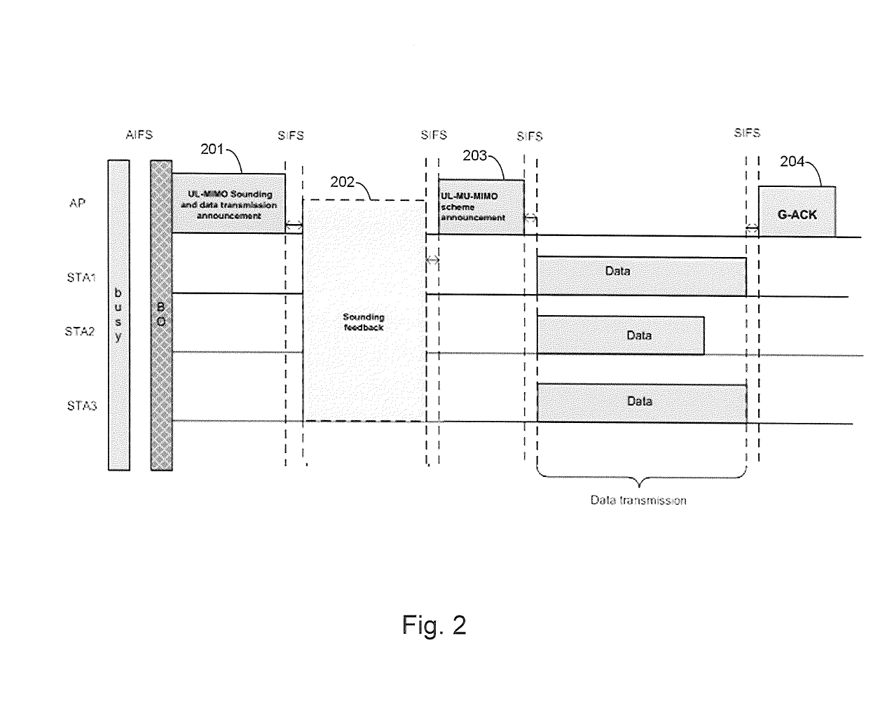

FIG. 2 provides an example of the timing of signals that are exchanged between the base station (AP) and three wireless user devices STA1, STA2, STA3, as discussed above with reference to FIG. 1. In this example, before sending a control frame, the base station (AP) determines whether a channel is free based on a Carrier Sense Multiple Access-Collision Avoidance (CSMA-CA) protocol; specifically, the base station senses whether a particular channel has been free for a predetermined period of time. The predetermined period may be computed as the combined duration of an arbitration inter-frame space (AIFS) and a back-off period associated with the base station, for example.

Having determined the channel to be free, the base station transmits the control frame 201 to the wireless user devices. In this example, the control frame includes a sounding announcement and data transmission announcement (as will be discussed below, in some embodiments the data transmission announcement may be sent at a later stage). In response to the UL-MU-MIMO control frame, the wireless user stations send sounding signals back to the base station during the sounding feedback period 202. The sounding signals may include training sequences on the basis of which the base station is able to determine the various communication parameters (frequency offset, power level, radio channel quality, timing delay etc.) associated with each user station.

After receiving the sounding signals from the users, the base station is able to then broadcast a UL-MU-MIMO scheme announcement 203, including timing advance values, frequency offset correction, transmit power levels, and details of the MIMO scheme to be used; these details may include the number of data streams, the type of modulation coding scheme, and precoding vector, for example.

After receiving the UL-MU-MIMO scheme announcement, the wireless user stations begin to transmit data to the base station in accordance with the parameters set out in the scheme announcement. On receiving the data from the user stations, the access point sends out an acknowledgement signal (G-ACK) 204 to confirm receipt of the data from each user station.

It will be understood that the precise intervals shown in FIG. 2 are provided by way of example only and that other intervals besides AIFS and the short inter-frame space (SIFS) may be used.

The UL-MU-MIMO transmission mechanisms described herein can be seen to comprise two parts: a sounding procedure and a data transmission procedure. The sounding procedure refers to the transmission of sounding signals from the wireless user stations and the reception of those sounding signals at the base station. The sounding procedure is initiated by the base station transmitting the sounding announcement, which announces a coming period as being dedicated to transmission and receipt of sounding signals from the user stations. The data transmission procedure involves the actual transmission of data from the user stations to the base station in accordance with the determined UL-MU-MIMO scheme.

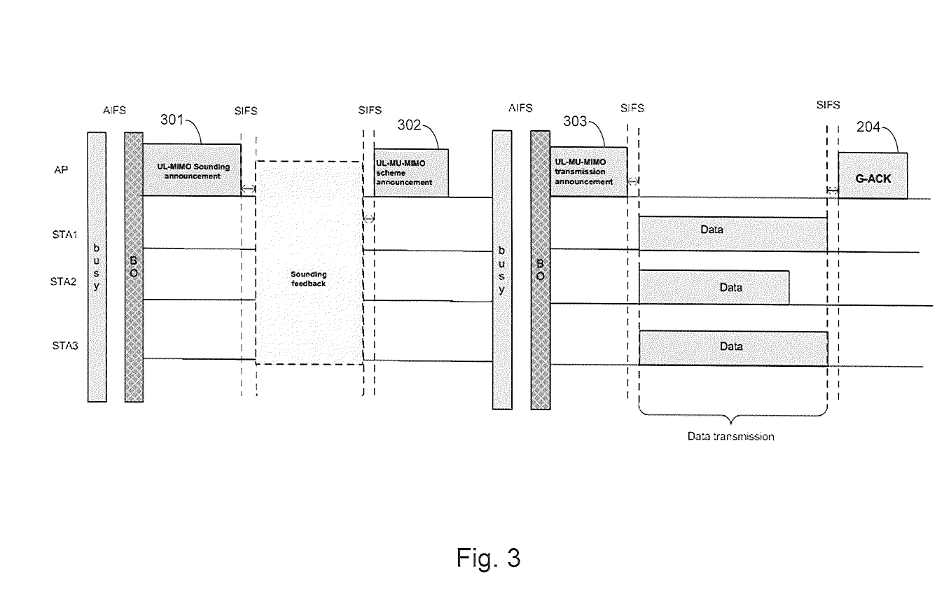

The user stations will only commence their data transmission once they have received the UL-MU-MIMO (data) transmission announcement from the base station. In some cases, such as that shown in FIG. 2, for example, the base station may include the transmission announcement as part of the control frame that is sent at the outset and which includes the sounding announcement. In other embodiments, in the event that the access point has limited time to compute an appropriate UL-MU-MIMO scheme, it may defer sending a UL-MU-MIMO transmission announcement until after the MIMO scheme has been computed and forwarded to the user stations. FIG. 3 shows an example of a case in which the transmission announcement 303 is sent separately from the sounding announcement 301, and after the MIMO scheme has been computed and broadcast in the scheme announcement 302. In this case, the base station will need to perform an additional step of contending the channel in order to win the opportunity to send the UL-MU-MIMO transmission announcement 303.

Embodiments described herein are backwards compatible with existing systems built upon the contention-based CSMA-CA media access mechanism. By forwarding the timing correction to the respective user stations, the base station is able to ensure that data from each user station will arrive at the base station at the same time. Consequently, the issue of non-synchronous reception of data from multiple user stations (and the associated degradation in receiver performance) can be avoided.

It will be understood that a number of different approaches may be employed as part of the sounding procedure; in what follows, examples of different methods for sending training sequences to the base station as part of the sounding signals will be described.

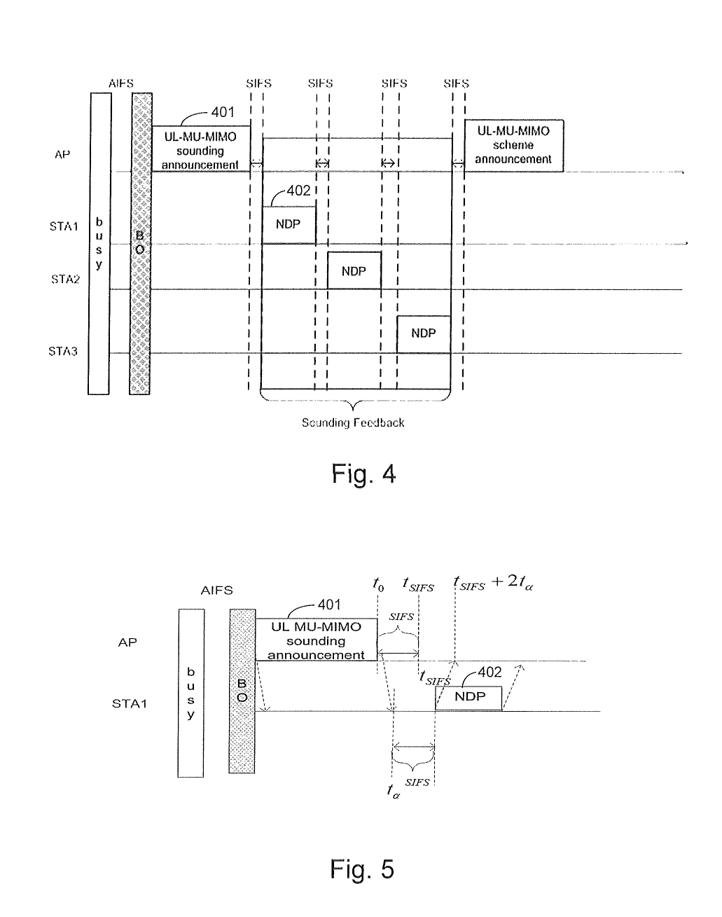

FIG. 4 shows an example of an embodiment in which a scheduling-based sounding feedback is used. In this embodiment, the control frame (sounding announcement) 401 that is sent from the base station to the wireless user stations defines an order in which the stations should respond with a sounding signal. For example, referring to FIG. 4, the k^{th} user commences sending its sounding signal at the time Tₖ=k×t_{SIFS}+Σᵢ₌₁^{k-1} tᵢ after the UL-MU-MIMO sounding announcement, where t_{SIFS} is again the length of the short inter-frame space (SIFS) and tᵢ is the duration of the sounding signal sent by the i^{th} previous user.

The time Tₖ at which each wireless user device is to commence sending its sounding signal to the base station can be communicated to the user stations via the UL-MU-MIMO sounding announcement or can be determined by the user stations themselves. In the latter case, if the sounding signals sent by different users have the same length, then the k^{th} user can easily determine Tₖ since the user already has knowledge of t_{SIFS}, and tᵢ. In this embodiment, the sounding signals sent by the wireless user devices may take the form of a null-data-packet (NDP) 402, this having been defined in the existing standard for DL-MU-MIMO.

FIG. 5 illustrates how the base station uses the received sounding signals to estimate the timing correction for each user when using the scheduling procedure described above. In the absence of any delay, the base station would expect the sounding announcement 401 to be received by the wireless user station at time t₀ and expect the wireless user station to begin transmitting a null-data-packet NDP 402 as sounding signal at an interval t_{SIFS} thereafter. However, as shown in FIG. 5, the user station STA1 will, in fact, receive the sounding announcement at an interval t_{α} after tₒ, meaning that transmission of the NDP training signal from the user station STA1 to the base station will be delayed by the period t_{α}. Similarly, once sent by the user station STA1, the NDP training signal will be delayed in arriving at the base station by a further interval t_{α}; thus, the NDP signal will be received at the base station at time t_{SIFS}+2t_{α} after tₒ. The base station is, therefore, able to use the arrival time of the NDP to determine that the transmission delay from the user station STA1 to the access point is t_{α}.

Having obtained the transmission delays t_{α} for each user station, the base station is able to calculate the timing correction that needs to be sent to each user station and which will determine the point at which each user station begins to transmit data to the base station. As an example, assuming t_{α}ⁱ is the transmission delay of the i^{th} user station, then the timing correction for the i^{th} user will be τᵢ=t_{α}ⁱ−minᵢ(t_{α}ⁱ). An alternative way to achieve the synchronous reception is to calculate the timing advance as τᵢ=t_{α}ⁱ−maxᵢ(t_{α}ⁱ), which is a negative value to indicate that the i^{th} user will start to transmit data at the time τᵢ after the SIFS space.

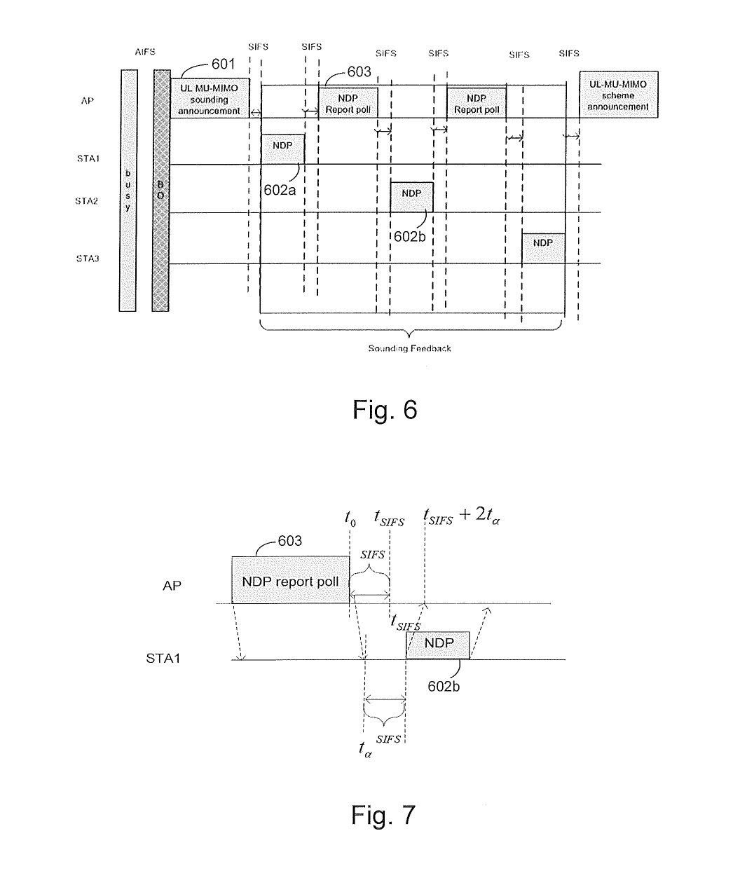

FIG. 6 shows an example of another embodiment in which a poll-based sounding feedback method is used. As in the previous embodiment, the control frame (sounding announcement) 601 that is sent from the base station to the wireless user stations defines an order in which the stations should respond with a sounding signal. In this case, the first user station sends its sounding signal 602 at a time t_{SIFS} after the UL-MU-MIMO control frame (sounding announcement). At a time t_{SIFS} after receiving the sounding signal from that user station, the base station sends an NDP-report-poll 603 to acknowledge receipt of the sounding signal 602a and to solicit the second user to send its sounding signal 602b. The procedure then continues until the last remaining user station has sent its sounding signal to the base station. The polling-based approach does not require as strict a timing as the scheduling-based approach shown in FIG. 4 and in addition, it allows the different user stations to send sounding signals of different durations from one another. However, extra signalling is required for the report poll. As before, the sounding signals sent by the wireless user devices may take the form of null-data-packets.

FIG. 7 illustrates how the base station uses the received sounding signals to estimate the timing correction for each user when using the poll-based procedure described above. The method is essentially the same as that shown in FIG. 5 for the scheduling based approach, but for user stations after the first user station, the base station bases its determination on the delay between sending the NDP-report poll 603 and receiving the sounding signal 602b from the next wireless user device. The timing correction for each user station can then be calculated in the same way as for the schedule-based method.

Depending on the type of sounding feedback method being used, the control frame may or may not include the addresses of specific users. In both the scheduling-based method of FIG. 4 and the poll-based method of FIG. 6, the UL-MU-MIMO sounding announcement control frame will be addressed to specific users, so that those user stations are informed of the need to send a sounding signal.

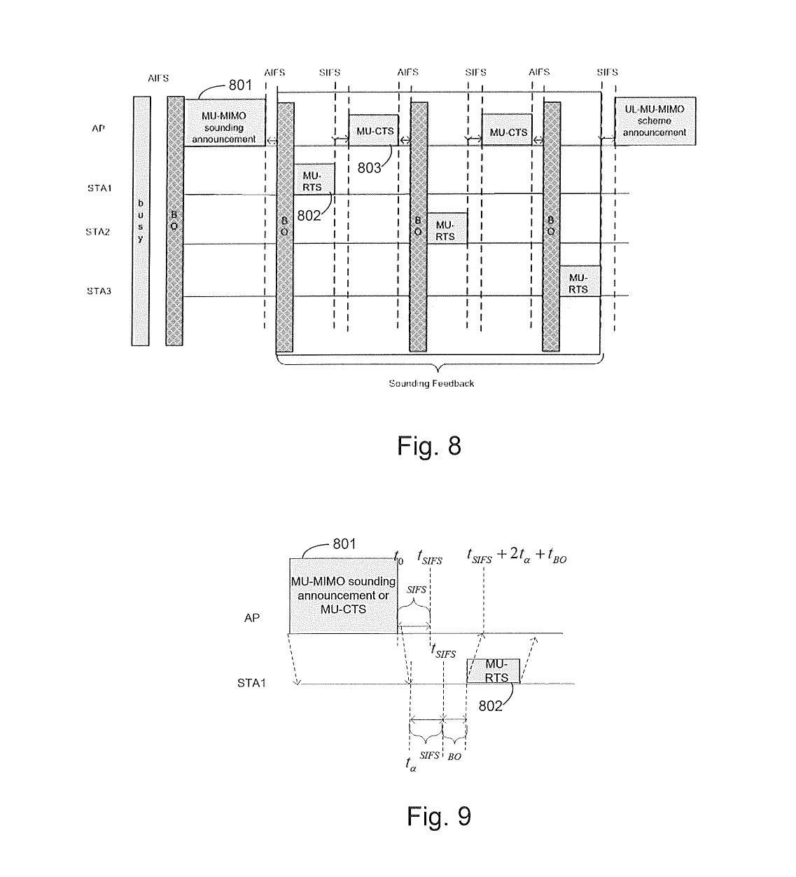

FIG. 8 shows an example of another embodiment, in which contention based sounding feedback is used. In this embodiment, the wireless user stations contend the chance to send a sounding signal after the UL-MU-MIMO sounding announcement. In this approach, the control frame need not include the addresses of specific users. The base station may address the control frame to a particular group of user stations to indicate that any member of that group can contend to send the sounding signal. As before, the access point commences by broadcasting a UL-MU-MIMO sounding announcement 801 using the normal CSMA/CA access mechanism. In this case, user stations that wish to respond by sending a sounding signal (MU-RTS) 802 are required to wait for a period defined by the sum of a shorter arbitration inter-frame space (AIFS) plus an individual back-off (BO). For each user station, the back-off is of random duration and lies between 0 and CW, where CW is the length of a back-off window. The sounding signal (MU-RTS) 802 includes the address of the user sending the sounding signal and the value of the associated back-off (BO).

On receiving a sounding signal 802 from a respective wireless user station, the base station sends an acknowledgement signal (MU-CTS) 803 to that user station. Following this, those user stations that still have yet to send a sounding signal contend the channel for the opportunity to do so. The procedure then continues until the number of user stations from which the base station has successfully received a sounding signal reaches a threshold or maximum number, where that threshold is pre-determined by the base station. The base station then transmits the UL-MU-MIMO scheme announcement.

In the contention based sounding feedback procedure of the present embodiment, the UL-MU-MIMO sounding announcement may include a maximum time duration which the feedback procedure cannot exceed, in case the base point falls to receive sufficient sounding signals due to collisions between transmissions, for example.

FIG. 9 shows how to estimate the timing delay for each user station in the present embodiment. Here, the MU-RTS signal will be received at the base station at time t_{SIFS}+2t_{α}+t_{BO} after tₒ where t_{BO} is the back-off associated with the user station in question. The base station is able to estimate the transmission delay as t_{BO} can be obtained from the MU-RTS sounding signal. The timing correction for each user station can then be calculated in the same way as for the schedule-based method and poll-based methods described above.

Embodiments described herein are compatible with CSMA-CA based access systems and so can be easily adapted to existing WiFi systems. Embodiments provide flexible sounding solutions such as scheduling-based, polling-based, and contend-based methods to suit different requirements.

Embodiments described herein may be implemented in various ways using different protocol frame format. In what follows, some examples are provided of how to define the frame based on the existing 802.11 MAC frame.

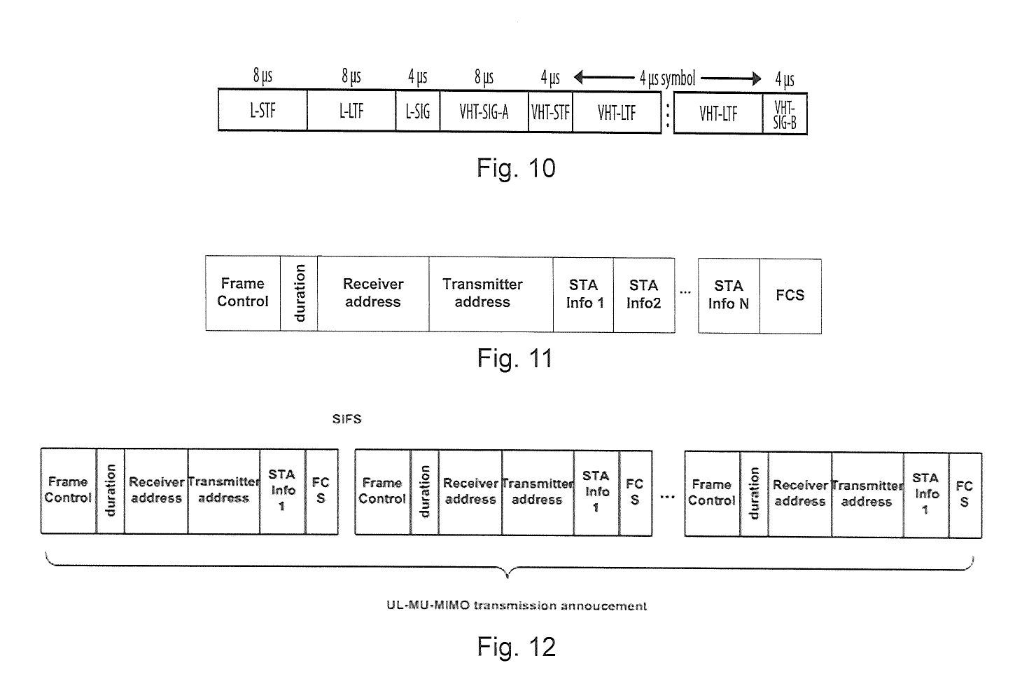

The NDP as described above in relation to the scheduling-based and polling based methods has been defined in the DL-MU-MIMO and can be reused here as shown in FIG. 10.

FIG. 11 shows an example of the format of the sounding announcement frame (control frame) as suitable for use in the scheduling and polling based embodiments (In the contention-based sounding approach, the control frame need not include the STA address fields). The UL-MU-MIMO transmission announcement can be defined to be similar as the one for the sounding announcement. Alternatively it can be split into consecutive frames for each user as shown in FIG. 12 in case one frame cannot handle all the information for the users due to the limitation of maximum length.

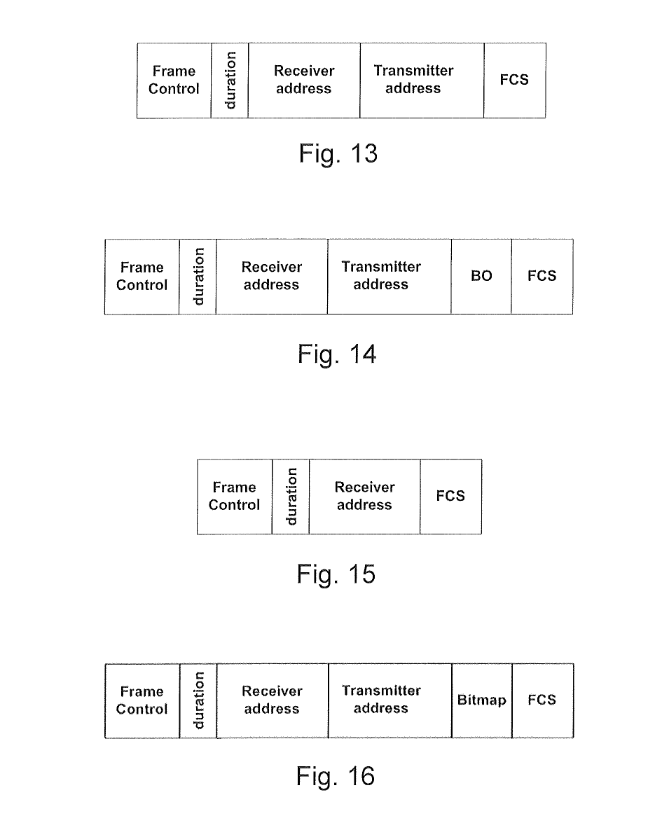

FIG. 13 shows an example of the format of the NDP report poll frame as suitable for use in the polling-based method. Here, the receiver address is the address of the user station that needs to feed back the sounding signal.

FIG. 14 shows an example of the format of the MU-RTS for use in the contention-based sounding approach; the MU-RTS is formed by adding a back-off value field to a conventional RTS. FIG. 15 shows an example of the MU-CTS, which is the same as the conventional CTS, but with a different value in the field of frame control.

Finally, FIG. 16 shows an example by adding a bitmap into the ACK to indicate if each data has been received successfully or not.

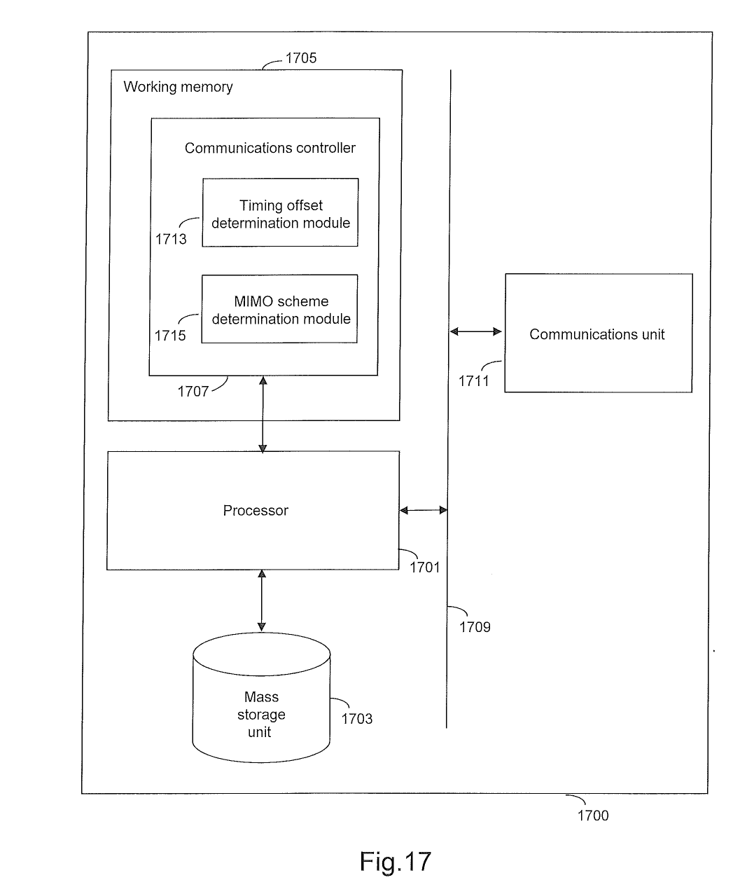

The reader will appreciate that a base station as described herein may be embodied as a computing device with means for wirelessly transmitting and/or receiving data from one or more wireless user devices such as mobile phones, computer laptops, tablets etc. An example base station is shown in FIG. 17, which provides means capable of putting an embodiment, as described herein, into effect. As illustrated, the computing device 1700 comprises a processor 1701 coupled to a mass storage unit 1703 and accessing a working memory 1705. As illustrated, a communications controller 1707 is represented as a software product stored in working memory 1705. However, it will be appreciated that elements of the communications controller 1707 may, for convenience, be stored in the mass storage unit 1703.

Usual procedures for the loading of software into memory and the storage of data in the mass storage unit 1703 apply. The processor 1701 also accesses, via bus 1709, a communications unit 1711 that operates to effect communications with the wireless user devices and for facilitating connection of those user devices to a network such as the internet or any local wireless or wired network. The communications unit 1711 will comprise one or more antennas to act as a transmitter and receiver for communicating via a MIMO scheme with the different user stations.

The communications controller 1707 includes a delay determination module 1715 that is operable to determine the time periods by which the different user devices should offset their respective transmissions so as to ensure synchronous arrival of data at the base station. The communications controller further includes a MIMO scheme determination module 1715 for determining a spatial transmission scheme by means of which data Is to be sent to and from the base station and the respective user devices. The timing correction information output from the delay determination module and the MIMO scheme are communicated to the user devices prior to uplink transmission of data from those devices to the base station. On receipt of data from the various user devices, the processor 1701 is able to process the received data based on the timing correction information and spatial transmission scheme.

The communications controller software 1707 can be embedded in original equipment, or can be provided, as a whole or in part, after manufacture. For instance, the communications controller software 1707 can be introduced, as a whole, as a computer program product, which may be in the form of a download, or to be introduced via a computer program storage medium, such as an optical disk. Alternatively, modifications to an existing computing device 1700 can be made by an update, or plug-in, to provide features of the above described embodiment.

While certain embodiments have been described, these embodiments have been presented by way of example only, and are not intended to limit the scope of the invention. Indeed, the novel methods, devices and systems described herein may be embodied in a variety of forms; furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

1. A method for implementing an uplink MU-MIMO protocol for data transmission from a plurality of wireless user stations to a base station, the method comprising:
transmitting a sounding announcement from the base station to the wireless user stations to solicit feedback of sounding signals from the wireless user stations;
receiving, at the base station, a respective sounding signal from two or more of the wireless user stations;
determining, based on the received sounding signals, the duration of a period by which each wireless user station from which a sounding signal has been received should offset its data transmission relative to the other wireless user stations from which a respective sounding signal has been received, so as to ensure synchronous arrival of data at the base station from those wireless user stations;
sending control announcement information to each wireless user station from which a sounding signal has been received, the control announcement information including a spatial transmission scheme and timing correction information defining the period for which those user stations are to offset their data transmission from one another;
receiving data sent from the respective wireless user stations to the base station; and
processing the received data based on the timing correction information and spatial transmission scheme.

2. A method according to claim 1 wherein the control announcement information further comprises a respective frequency offset and/or transmission power to be implemented by each wireless user station.

3. A method according to claim 1 or 2, wherein the sounding announcement is addressed to specific user stations to prompt those user stations to send their respective sounding signals to the base station.

4. A method according to claim 3, wherein the sounding announcement defines an order in which the user stations are to send their respective sounding signals to the base station.

5. A method according to claim 3 or 4, wherein the sounding announcement defines timings for when each user station is to transmit its respective sounding signal.

6. A method according to any one of claims 3 to 5 wherein on receipt of a respective sounding signal from a wireless user station, the base station transmits an acknowledgement to that user station.

7. A method according to claim 6, wherein the transmission of the acknowledgement from the base station prompts the next user station to transmit its sounding signal.

8. A method according to any one of claims 1 to 7, wherein the sounding signals sent from the respective wireless user stations are sent from each station in turn based on a CSMA-CA protocol.

9. A method according to claim 8, wherein the sounding signal received from a respective wireless user station includes the value of a back-off associated with that user station.

10. A method according to any one of the preceding claims, wherein the base station determines the duration of the period by which each respective wireless user station should offset its data transmission based on the delay between the expected arrival time of the respective sounding signal at the base station and the actual arrival time of the sounding signal at the base station.

11. A method according to claim 10, wherein the base station determines the duration of the period by which each respective wireless user station should offset its data transmission by:
determining a first delay between the expected arrival time and actual arrival time of a sounding signal from a first one of the wireless user stations;
determining, for each one of the other user stations, the difference between the first delay and the delay between the expected arrival time and actual arrival time of the sounding signal from the respective wireless user station.

12. A method according to claim 11, wherein the first one of the wireless user stations is the wireless user station for which the delay between the expected arrival time and actual arrival time is greatest.

13. A method according to claim 11, wherein the first one of the wireless user stations is the wireless user station for which the delay between the expected arrival time and actual arrival time is smallest.

14. A method according to any one of the preceding claims, wherein before sending the sounding announcement, the base station determines whether a channel for sending the announcement is free based on a CSMA-CA protocol.

15. A method according to any one of the preceding claims, wherein the sounding signals take the form of null data packets.

16. A method according to any one of the preceding claims, wherein on receipt of data from a respective user station, the base station sends an acknowledgement to the user station.

17. A method according to claim 16, wherein the acknowledgement sent on receipt of data includes a bitmap indicating whether the data has been successfully received.

18. A non-transitory computer readable storage medium comprising computer executable instructions that when executed by a computer will cause the computer to carry out the method of any one of the preceding claims.

19. A base station for coordinating transmission of data from a plurality of wireless user stations using an uplink MU-MIMO protocol, the base station comprising:
a transmitter for transmitting a sounding announcement to the wireless user stations to solicit feedback of sounding signals from the wireless user stations;
a receiver for receiving a respective sounding signal from two or more of the wireless user stations;
a timing offset determination module for determining, based on the received sounding signals, the duration of a period by which each respective wireless user station from which a sounding signal has been received should offset its data transmission relative to the other wireless user stations from which a respective sounding signal has been received, so as to ensure synchronous arrival of data at the base station from those wireless user stations;
the transmitter being configured to send control announcement information to each wireless user station from which a sounding signal has been received, the control announcement information including a spatial transmission scheme and timing correction information defining the period by which those respective user stations are to offset their data transmissions relative to one another;
the receiver being configured to receive data sent from the respective wireless user stations to the base station using the spatial transmission scheme;
the base station including a processor for processing the received data based on the timing correction information and spatial transmission scheme.

20. A wireless network comprising a base station according to claim 19 and a plurality of wireless user stations, the wireless user stations being configured to transmit data to the base station via the uplink MU-MIMO protocol.
